(19) United States
(12) Patent Application Publication
(10) Pub. No.: US 2010/0197832 A1
(43) Pub. Date: Aug. 5, 2010

(54) ISOLATED NANOTUBES AND POLYMER NANOCOMPOSITES

(75) Inventors: Dazhi SUN, College Station, TX (US); Hung-Jue SUE, College Station, TX (US)

Correspondence Address: CONLEY ROSE, P.C.;David A. Rose, P. O. BOX 3267, HOUSTON, TX, 77253-3267, US

(73) Assignee: TEXAS A&M UNIVERSITY SYSTEM, College Station, TX (US)

(21) Appl. No.: 12/698,602

(22) Filed: Feb. 2, 2010

Related U.S. Application Data
(60) Provisional application No. 61/150,192, filed on Feb. 5, 2009.

(51) Int. Cl. C08L 63/00

(52) U.S. Cl. 523/468; 977/742; 977/752; 977/750

(57) ABSTRACT

A method for producing a nanocomposite, the nanocomposite comprises at least one nanofiller, wherein said nanofiller comprises at least one nanotube, and a medium comprising a polymeric matrix. Further, the nanotube comprises at least one exfoliated nanotube. The method comprises agglomerating at least one nanotube from a nanotube and nanoplatelet dispersion in a solvent. Additionally, the method comprises redispersing at least one nanotube in a matrix precursor solution.

### CROSS-REFERENCE TO RELATED APPLICATIONS

This application claims the benefit under 35 U.S.C. §119(e) of U.S. Provisional Patent Application No. 61/150,192 filed Feb. 5, 2009, the disclosure of which is hereby incorporated by reference.

### STATEMENT REGARDING FEDERALLY SPONSORED RESEARCH OR DEVELOPMENT

Not applicable.

### BACKGROUND

1. Field of the Invention

This invention relates generally to the field of nanotube nanocomposites, and more specifically to a method of isolating nanotubes for forming nanocomposites.

2. Background of the Invention

Nanotubes are a novel class of nanostructures that exhibit remarkable mechanical, electrical, and thermal properties, thus having potential applications such as nanoscale probe devices, energy storage components, sensors, flame retardant materials, and electrical conductors in the aerospace, automotive, micro-electric, photovoltaic, and energy transmission industries. In addition, nanotubes may be constructed of a variety of different materials, including carbon, silicon, metal-oxide, and other inorganic compounds. Nanotubes may be classified as multi-walled nanotubes (MWNT), few walled nanotubes (FWNT), and single walled nanotubes (SWNT).

Specifically, after synthesis, SWNT demonstrate an affinity for forming into roped, bundled, or entangled configurations. The aggregated nanotube bundles do not yield the expected advantageous properties. The technical advantage of dispersing nanotubes for use in organic and inorganic media has implications in creating materials with uniform nanotube distribution acting as a structural, mechanical, conductive, or thermal component of the material.

Aggregation and bundling of nanotubes represents a constraint for implementation of these structures to maximize their advantageous properties in nanoscale applications. Furthermore, the homogeneous incorporation of nanotubes in compositions is restricted. Due to the difficulty in completely dispersing nanotube bundles, the differential control over the location and orientation of the individual nanotubes represent an additional hurdle to commercial applications. Methods utilizing high temperatures and lasers for post-deposition alignment have been academically tested.

However, these methods are impractical for fabricating polymer nanocomposites because the techniques ablate, damage, or otherwise alter the supporting polymer matrix irreversibly. Further, these techniques are highly impractical for implementation into the conventional molding and extrusion processes commonly used to produce final plastic components. Consequently, there is a need for a method of dispersing nanotubes and creating polymer nanotube nanocomposites.

### BRIEF SUMMARY

A method for producing a nanotube reinforced nanocomposite. In one embodiment, the nanocomposite comprises at least one nanofiller, wherein said nanofiller comprises at least one nanotube, a medium, wherein said medium comprises a polymeric matrix; and wherein at least one nanotube is exfoliated within the medium.

Further, the method may also comprise agglomerating the at least one nanotube to form a nanotube dispersion in a solvent. The method may further comprise adding a solvent to a nanofiller suspension to agglomerate the at least one nanotube, and removing the at least one nanotube from the nanofiller suspension.

The foregoing has outlined rather broadly the features and technical advantages of the invention in order that the detailed description of the invention that follows may be better understood. It should be appreciated by those skilled in the art that the conception and the specific embodiments disclosed may be readily utilized as a basis for modifying or designing other structures for carrying out the same purposes of the invention. It should also be realized by those skilled in the art that such equivalent constructions do not depart from the spirit and scope of the invention as set forth in the appended claims.

### BRIEF DESCRIPTION OF THE DRAWINGS

For a detailed description of the preferred embodiments of the invention, reference will now be made to the accompanying drawings, in which:

FIG. 1 illustrates a conceptual scheme for the preparation of epoxy nanocomposites containing individually dispersed CNTs and exfoliated nanoplatelets.

FIG. 2A illustrates a TEM image of MWNTs

FIG. 2B illustrates a SEM image of pristine α-ZrP nanoplatelets

FIG. 2B INSET is a TEM image of a monolayer α-ZrP nanoplatelet exfoliated by TBA.

FIG. 3A illustrates a comparison of Raman Spectroscopy between dispersed SWNTs and bundled SWNTs.

FIG. 3B illustrates a comparison of Raman spectroscopy between dispersed SWNTs and bundled SWNTs.

FIG. 4 illustrates a comparison of UV-vis NIR Spectroscopy dispersed SWNTs and bundled ‘raw’ SWNTs.

FIG. 5 illustrates the XRD patterns of the hybrid solids containing ZrP nanoplatelets and CNTs with different weight ratios prepared by drying aqueous suspensions and cartoons of the morphologies of each hybrid solid.

FIG. 6A illustrates TEM images of epoxy nanocomposites containing 0.2 wt. % of MWNTs and 1.0 wt. % of ZrP nanoplatelets, with arrows indicating exfoliated ZrP nanoplatelets

FIG. 6B illustrates TEM images of epoxy nanocomposites containing b) 0.4 wt. % of MWNTs and 2.0 wt. % of ZrP nanoplatelets, with arrows indicating exfoliated ZrP nanoplatelets

FIG. 7A illustrates a TEM image of entangled SWNT bundles before dispersion

FIG. 7B illustrates TEM images of epoxy nanocomposites containing 0.2 wt. % of SWNTs and 1.0 wt. % of ZrP nanoplatelets The white arrows indicate some of the exfoliated ZrP nanoplatelets and the black arrows are individually dispersed and straight SWNTs.

FIG. 7C illustrates TEM images of epoxy nanocomposites containing 0.4 wt. % of SWNTs and 2.0 wt. % of ZrP nanoplatelets. The blue arrows indicate some of the exfoliated ZrP nanoplatelets and the red arrows are individually dispersed and straight SWNTs.

FIG. 8 illustrates the stress/strain curves of the neat epoxy and two epoxy nanocomposites containing exfoliated ZrP nanoplatelets and MWNTs.

### NOTATION AND NOMENCLATURE

Certain terms are used throughout the following descriptions and claims to refer to particular system components. This document does not intend to distinguish between components that differ in name but not function.

As used herein, the term “nanotube(s)” or NT(s) refers to any cylindrical atomic allotrope or polyatomic molecule with a diameter of at least about 0.7 nm, a length greater than about 30 nm, an aspect ratio (length to diameter ratio) of at least about 10 and outer walls comprising one or more layers.

As used herein, the term “single walled nanotube(s)” or “SWNT(s)” refers to any nanotube with outer walls comprising one layer. Additionally, the term “multi-walled nanotube(s)” or “MWNT(s)” refers to any nanotube with outer walls comprising at least 2 layers.

As used herein, the term “carbon nanotube(s)” or CNT(s) refers to any cylindrical carbon allotrope, with a diameter of about 0.7 nm, and outer walls comprising one or more graphene layers.

Also, as used herein, the terms “disperse”, “de-rope”, or “de-bundle” refer to the substantial separation or disentanglement of individual nanotubes from a bundle, rope, aggregate, clump, intertwined, or similar conformation compromising one or more nanotubes in association with each other.

Additionally, as used herein, the term “exfoliate” relates to the process of removing a layer from a material. “Exfoliated” as used herein refers to a nanostructure that has been stripped to one layer. Alternatively, “exfoliated” as used herein refers to individually dispersed, or monodisperse nanotubes.

In addition, as used herein, the term “nanocomposite” or “hybrid” refers to a combination of, mixture of, or composite of the materials preceding the term but is not limited to only the included materials.

Furthermore, as used herein, the term “microchannels” is used to relate to channels within a substrate or bulk material with a cross sectional diameter of at most 1 millimeter.

### DETAILED DESCRIPTION OF THE PREFERRED EMBODIMENTS

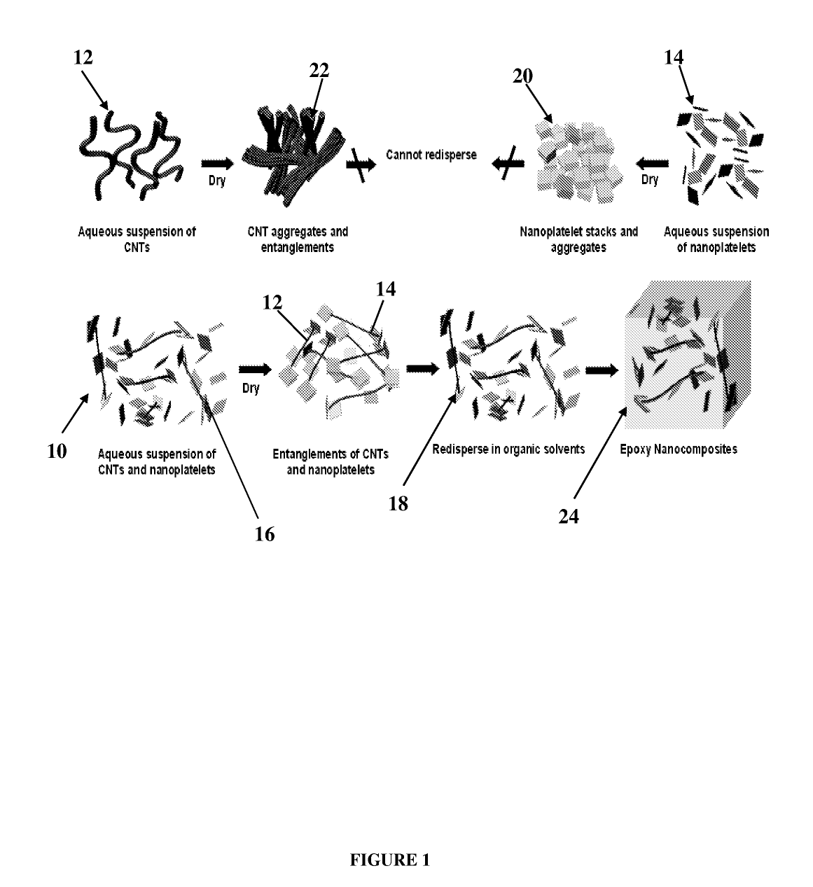

This disclosure relates generally to, and uses the principles disclosed in U.S. patent application Ser. No. 12/112,675, entitled “Dispersion, Alignment and Deposition of Nanotubes”, the disclosure of which is hereby incorporated by reference for all purposes. In embodiments, the present disclosure presents novel methods for the dispersion of nanotubes. The conceptual schematic of FIG. 1 illustrates some of the features of the present disclosure. Oxidized, suspended carbon nanotubes (CNTs) 12 mixed the aqueous solutions of nanoplatelets 14 are capable of being mixed to produce a loosely-structured, electrostatically-linked, and dispersible nanofiller 16, for implementation in nanocomposites 24, and the like. In certain instances, the electrostatic association of nanotubes 12 and nanoplatelets 14 in solutions or solvents 18 forms a dispersion 10. The dispersion 10 may be regulated by fine control of the ionic strength of the solution. Alternate embodiments include separating the nanotubes 12 from the nanoplatelets 14, for further applications in nanocomposite materials.

Nanotubes. The nanotubes 12, illustrated for example in FIG. 1, manipulated in the disclosed invention are any commercially available. The nanotubes employed in embodiments of the disclosed method are of any synthetic classification, as understood by those skilled in the art. The nanotubes may be comprised of any materials such as, but not limited to, carbon, silicon, metals, or inorganic compounds. In certain instances, the nanotubes comprise carbon nanotubes. The carbon nanotubes have a diameter of between about 1 nm and about 20 nm and alternately, may have a diameter of greater than about 20 nm. As may be understood by one skilled in the art, a MWNT may have a diameter that is greater than about 50 nm.

The carbon nanotube length is at least about 100 nm; alternately, at least about 1000 nm, and in certain instances, the length of the nanotubes may exceed 1 μm. The nanotubes have an aspect ratio, or length to diameter ratio, of at least about 10. The carbon nanotube aspect ratio is at least about 20; and alternately, the aspect ratio is at least about 1,000. Further, the aspect ratio may greater than about 1,500; and alternatively the aspect ratio may be greater than about 10,000. The nanotubes may comprise, without limitation, single walled nanotubes, few walled nanotubes, multi-walled nanotubes or combinations thereof. The carbon nanotubes comprise single walled carbon nanotubes (SWNTs) or multi-walled carbon nanotubes (MWNTs). In certain instances, MWNTs may comprise a slightly longer length, and have a higher aspect ratio, compared to the SWNTs. In certain instances, MWNTs are preferred for their length and aspect ratio. Alternately, the SWNTs may be preferred as they have unique properties compared to the MWNTs

The nanotubes are chemically modified, or surface modified, for instance functionalized. In certain instances, the nanotubes are oxidized by pre-treatment in at least one acid. In further embodiments, the nanotubes may be oxidized in a solution of acids. The acid may comprise, hydrochloric, hydrobromic, sulfuric, nitric, chromic, phosphoric, acetic, citric, formic, lactic, ascorbic, and/or other acids known to those skilled in the art. In embodiments, the acid may comprise a mixture of sulfuric acid and nitric acid. Further, in embodiments, the nitric acid to sulfuric acid ratio is approximately 3:1.

Nanoplatelets. The nanoplatelets 14 are nanoparticles, illustrated for example in FIG. 1, having a thin, planar geometry. The nanoplatelets may comprise any shape, without limitation, such as circular, rectangular, triangular, and hexagonal. Further, the nanoplatelets comprises any substantially two-dimensional shape, such as round, or polygonal without limitation. In embodiments, the nanoplatelets have a diameter range from about 10 nm to about 20,000 nm, and preferably between about 100 nm and 1000 nm. Nanoplatelets have an aspect ratio, diameter to thickness ratio, of between about 10 and about 20,000; preferably the aspect ratio is between about 100 and about 4000; and most preferably between about 100 and 500.

The nanoplatelets comprise any suitable material, as known to one skilled in the art without limitation, such as clay, nanoclay, graphite, inorganic crystal, organic crystal, and combinations thereof. In certain embodiments, nanoplatelets comprise an inorganic crystal; such as alpha-zirconium phosphate (ZrP). In instances, the nanoplatelets comprise exfoliated nanoplatelets. Exfoliated nanoplatelets comprise nanoplatelets that are chemically separated into individual crystalline layers. In certain instances, the exfoliated nanoplatelets have a positive electrostatic charge on the surface of both sides. The exfoliated nanoplatelets are formed in a chemically active media. The chemically active media comprises any solution known to exchange protons, for instance basic-aqueous solution, as may be understood by a skilled artisan. Examples of suitable solutions that may be used include water, alcohol-water, amine bases, hydrocarbon solutions, salt solutions, aqueous base solutions, and combinations thereof.

Exfoliated Nanotubes. In order to exfoliate and disperse the oxidized nanotubes, the aqueous-oxidized nanotube solution, and aqueous-exfoliated nanoplatelet solution are admixed, directly, and agitated to form a dispersion 10. Examples of agitation methods that may be used include without limitation shaking, stirring, sonication, or other mechanical means; in certain instances, the mixture is stirred. After initial mechanical agitation, the mixture is homogenized by ultra-sonication. The time and temperature for homogenization are dependent on ultra-sonicator power and bath efficiency.

After ultra-sonication, the aqueous nanotube-nanoplatelet dispersion 10 is a substantially homogenous solution of dispersed nanotubes 12 and associated nanoplatelets 14. The concentrations of nanotubes and nanoplatelets are measured in parts per million. The concentration of nanotubes 12 in the dispersion 10 is between about 0 ppm and about 1000 ppm; alternately between about 100 ppm and about 500 ppm; and in certain instances, the concentration of nanotubes is about 200 ppm. In further alternate instances, the concentration of nanotubes maybe at least 1 wt %. The concentration of nanoplatelets 14 in the dispersion 10 is between about 100 ppm and about 5000 ppm; alternately, between about 500 ppm and about 2500 ppm; and in certain instances about 1000 ppm. The ratio of the concentration of nanotubes 12 to nanoplatelets 14 may be between about 1:1 and about 1:20. In certain instances, the weight ratio of nanotubes to nanoplatelets is about 1:5. Without limitation by theory, the ratios of the nanotubes to nanoplatelets are dependent on the aspect ratios and charge strengths of the nanoplatelets. The solution may be dried to form a nanocomposite powder. In certain instances, the nanocomposite powder is a nanofiller. The nanofiller is suitable for re-suspension in any solvent, or solution as understood by one skilled in the art.

The exfoliation and dispersion of nanotubes is attributed to the presence of the nanoplatelets. Without being limited by theory, the negatively charged surface of nanotubes, for instance example oxidation, attracts the positively charged surface of the nanoplatelets, for example after exfoliation. By mixing the positively charged nanoplatelets with negatively charged bundled nanotubes, the nanoplatelets attach to the nanotube walls, and at least partially enter between nanotubes of the bundles. The nanoplatelets force the nanotube bundles into individual tubes with mechanical agitation, for example during ultrasonication. The positively charged nanoplatelets are electrostatically tethered to the negatively charged nanotubes. After the separation of the nanotubes, the nanoplatelets have individual, exfoliated, or separated tubes attached, or tethered to the surfaces of the nanoplatelets. The nanoplatelets cannot be re-stacked together to form regular layered structures 20, as shown in FIG. 1, due to the presence of nanotubes. Thus, each nanoparticle interferes with the re-aggregation, or re-bundling of the nanotubes by a steric, or physical, hindrance effect. The hindering effect comes from the two-dimensional heterogeneous shapes of the nanoplatelets interfering with other nanoplatelets associated with nearby nanotubes. The surface charge and two-dimensional nature of exfoliated nanoplatelets disperse the nanotubes and hinder the re-aggregation thereof. The nanotubes dispersed by the nanoplatelets are exfoliated nanotubes.

Nanofiller. The nanotubes and nanoplatelets are electrostatically associated. The nanotube-nanoplatelet association comprises a nanofiller 16, as illustrated in FIG. 1. In certain applications, a nanofiller may be dispersed in a medium such as, but not limited to epoxy, plastic, or polymer, to form a nanocomposites 24. As understood by one skilled in the art, an epoxy may comprise any thermosetting polymer that cures, crosslinks, and/or hardens when mixed with a catalyzing agent. Without being limited by theory, the nanofiller increases or improves the physical, mechanical, or chemical properties of the medium. The nanofiller may be re-suspended in any solvent that is chemically compatible with a desired medium. In an embodiment, the nanofiller is re-suspended in acetone prior to mixing in an epoxy. In a potential exemplary application, the epoxy comprises an epoxy monomer. In certain instances, the epoxy monomer comprises diglycidyl ether of bisphenol-A. The concentration of nanotubes in the epoxy is between about 0.01 wt % and about 50 wt %. In certain instances, the nanotube concentration may exceed 50 wt %, for example when using MWNTs. Alternatively, the nanotube concentration is between about 0.05 wt % and about 0.6 wt %; alternatively, between about 0.1 wt % and about 0.4 wt %. The nanoplatelet concentrations in the epoxy is between about 0.1 wt % and about 5 wt %; alternatively, between about 0.5 wt % and about 3 wt %, and in instances, between about 1.0 wt % and about 2.0 wt %. The ratio of nanotube concentration to nanoplatelet concentration is about 1:5. As may be understood by one skilled in the art, the ratio of nanotube concentration to nanoplatelet concentration may vary. For example and in certain instances, higher aspect ratio nanoplatelets may exhibit improved exfoliation of the nanotubes. In certain instances, the ratio of nanotube concentration to nanoplatelet concentration is about 1:3; alternatively about 1:2. Without wishing to be limited by theory, thermodynamic efficiency may affect the concentration ratio, for example, by implementing alternate surfactants, improved sonicators, and/or increased temperatures. The ratio of nanotube concentration to nanoplatelet concentration may vary from about 1:1 to about 1:20 depending on the processes and apparatuses used. Without limitation by theory, the ratio of the nanotubes to nanoplatelets is dependent on the aspect ratios and charge strengths of the nanoplatelets.

The nanofiller and epoxy mixture comprises a nanocomposite 24, or epoxy nanocomposite, as shown in FIG. 1. The solvent is removed from the nanocomposite and the solvent removed from the epoxy nanocomposite by any means known to one skilled in the art. Examples of suitable means for removing solvent comprise vacuum evaporation, solvent exchange, and centrifugation, without limitation. In instances, the solvent is removed from the epoxy nanocomposite by rotary evaporation. The rotary evaporation is conducted in a water bath between about 20° C. and about 100° C. and alternatively, at about 80° C. A curing agent is added to the epoxy and nanotubes, and heated to polymerize, crosslink, vulcanize, or otherwise cure, without limitation, the epoxy nanocomposite. In certain instances, the curing agent comprises 4,4′-diamino-diphenyl sulfone, hereinafter, DDS. The DDS is added to the epoxy nanocomposite at a stoichiometric ratio. In embodiments, the curing agent and epoxy nanocomposite mixture are heated up rapidly to a temperature between about 80° C. and about 200° C., and alternatively at about 130° C. Further, the mixture is heated until the DDS is completely dissolved. The mixture is poured into a mold with mold release agent on the surfaces. In certain instances, the mold comprises a pre-heated glass mold. The epoxy nanocomposite is cured in an oven at about 180° C. for 2 hours. Further, the epoxy nanocomposite is heated for 2 hours post-cure at about 220° C. As understood by one skilled in the art, the temperature, time for curing, and post-cure heating may differ with the composition of the epoxy, polymer, plastic, or composite material. In certain instances, the nanofiller may be used for additional materials other than epoxies. For example, the nanofiller material may be incorporated into plastics, alloys, composites, and other materials without limitation.

Precipitation. In embodiments, the nanotube-nanoplatelet nanocomposite may be separated, prior to incorporation into a medium. In instances, at least one surfactant is added the nanotube-nanoplatelet mixture to separate the nanotubes and nanoplatelets. In certain instances, the surfactant is sufficient to separate the nanotubes and nanoplatelets. The surfactant solution is without further components such as ions, ionic salts, polar compounds, and/or polar salts. Preferably, the surfactant alters the ionic balance of the suspension. In certain instances, the surfactant comprises an ionic surfactant. The surfactant may preferably comprise sodium dodecyl sulfate (SDS). Alternatively, the surfactant comprises polystyrene sulfonate (PSS). The surfactant is added to achieve a concentration of between about 0.05 wt % and about 5 wt %; between about 0.5 wt % and about 1.5 wt %; and in embodiments about 1.0 wt %. As may be understood by one skilled in the art, less effective surfactants may require concentrations that are greater than about 5 wt %. The surfactant solution of nanoplatelets and nanotubes is sonicated. The time and temperature of the sonication are dependent on sonicator power and bath efficiency. Alternatively, the surfactant solution of nanoplatelets and nanotubes is sonicated for between about 15 minutes and about 2 hours, between about 30 minutes and about 45 minutes. In certain instances, the surfactant solution is sonicated for about 30 minutes. The temperature is maintained at about room temperature; alternatively, at any temperature above about 0° C.

In order to remove the carbon nanotubes from the nanocomposite surfactant solution, a solvent may be added. The solvent may be any that solve known to agglomerate, precipitate, or otherwise isolate the carbon nanotubes. In certain instances, the solvent is a polar solvent. Further, the solvent may comprise a solvent that is miscible in water, alcohols, polymers, and other liquids, without limitation. In instances, the solvent is acetone or tetrahydrafuran (THF). The ratio of volume solvent to volume surfactant is about 1:20, preferably about 1:5, and in certain instances, about 1:1. Alternatively, 5 mL of acetone was added into the solution, comprising a volume of about 5 mL to about 30 mL. The addition of the solvent to the surfactant solution loosely agglomerates the carbon nanotubes. The agglomerated carbon nanotubes are released from the nanoplatelet-nanotube nanocomposite. The agglomerated nanotubes remain suspended in the surfactant solution in loosely associated clumps.

The agglomerated nanotubes are removed from the surfactant solution. Separation of the nanotubes from the nanoplatelet containing surfactant may include filtration, precipitation/decanting, or centrifugation, without limitation. In one instance, the agglomerated nanotubes are collected by centrifugation at 5000 rpm for 15 min. As will be understood by one skilled in the art, the agglomerated nanotubes may be removed from the surfactant solution by centrifugation for an alternate period and rotational frequency. In certain instances, the diameter of the rotor and rotational frequency may dictate the relative centrifugal force applied to the surfactant, and alter the time necessary to pellet the nanotubes.

After centrifugation, the supernatant, comprising surfactant and suspended nanoplatelets, is decanted to prevent the re-aggregation of the nanotube and nanoplatelet nanofiller. After decanting the surfactant and nanoplatelet containing supernatant, the nanotubes in the comprising pellet may be washed. The nanotubes are washed at least once in the solvent. In certain instances the nanotubes are washed, between about 1 time and about 5 times in the solvent. Alternatively, the nanotubes are washed between about 2 times and about 4 times. In certain instances, the pellet comprising the nanotubes is washed at least 2 times in the solvent. As described hereinabove in an exemplary instance, the solvent comprises acetone. Further, the nanotubes are washed in an aqueous solution comprising any aqueous solution known to one skilled in the art, to remove the solvent. The aqueous solution de-ionized water. In embodiments, the nanotubes are washed between 1 and 5 times; alternatively, between about 2 times and about 4 time; and preferably at least about 3 times in the aqueous solution.

In certain instances, the supernatant is collected and dried. Further, the supernatants from the washing steps may be collected and dried. The dried supernatants comprise a residue. Further, the mass and quantity of separated nanoplatelets may be determined by weight of the residue. Without limitation, weighing the nanoplatelet residues comprises a means to verify the concentration of nanoplatelets by mass.

Nanotube Nanocomposites. The isolated, agglomerated nanotubes are suitable for redispersion. The nanotubes are redispersed into different mediums, materials, matrices, plastics, polymers, composites, and the like without limitations. The different mediums comprise, a surfactant, such as but not limited to piperidine, sodium dodecyl sulfate (SDS), poly-styrene-sulfonate (PSS), hexadecyltrimethylammonium bromide (CTAB), and polyvinyl pyrrolidone (PVP). In certain instances, the medium comprises any known ionic or nonionic surfactant. Without being limited by theory, a surfactant improves the suspension of nanotubes in solutions by reducing the surface tension, hydrophobic, hydrophilic, and/or other thermodynamic interactions between the nanotubes and the medium. In further instances, the nanotubes are dispersed in liquid precursors directly. The liquid precursors are any curable matrix or medium, such as epoxies, plastics, alloys, composites, and other materials without limitation. In further instances, the liquid precursors are hardened or cured by any means known in the art, for example, by heating, drying, or mixing with a hardener or curing agent. A curing agent is added to the liquid precursors and nanotubes, and heated to polymerize, crosslink, vulcanize, or otherwise cure, without limitation, to form a nanotube nanocomposite. For example, a curing agent comprises 4,4′-diamino-diphenyl sulfone, hereinafter, DDS, is added to epoxies for nanocomposites. The DDS is added to the nanocomposites at a stoichiometric ratio. The curing agent and nanotube nanocomposite mixture are heated up rapidly to a temperature between about 80° C. and about 200° C., and alternatively at about 130° C. Further, the mixture is heated until the DDS is completely dissolved. The mixture is poured into a mold with mold release agent on the surfaces. In certain instances, the mold comprises a pre-heated glass mold. The nanotube nanocomposite is cured in an oven at about 180° C. for 2 hours. Further, the nanotube nanocomposite is heated for 2 hours post-cure at about 220° C. As understood by one skilled in the art, the temperature, time for curing, and post-cure heating may differ with the composition of the epoxy, polymer, plastic, alloy, or composite material.

While the preferred embodiments of the invention have been shown and described, modifications thereof can be made by one skilled in the art without departing from the spirit and teachings of the invention. The embodiments described and the examples provided herein are exemplary only, and are not intended to be limiting. Many variations and modifications of the invention disclosed herein are possible and are within the scope of the invention. Accordingly, the scope of protection is not limited by the description set out above, but is only limited by the claims, which follow, that scope including all equivalents of the subject matter of the claims. To further illustrate various embodiments of the present invention, the following examples are provided.

### Example 1

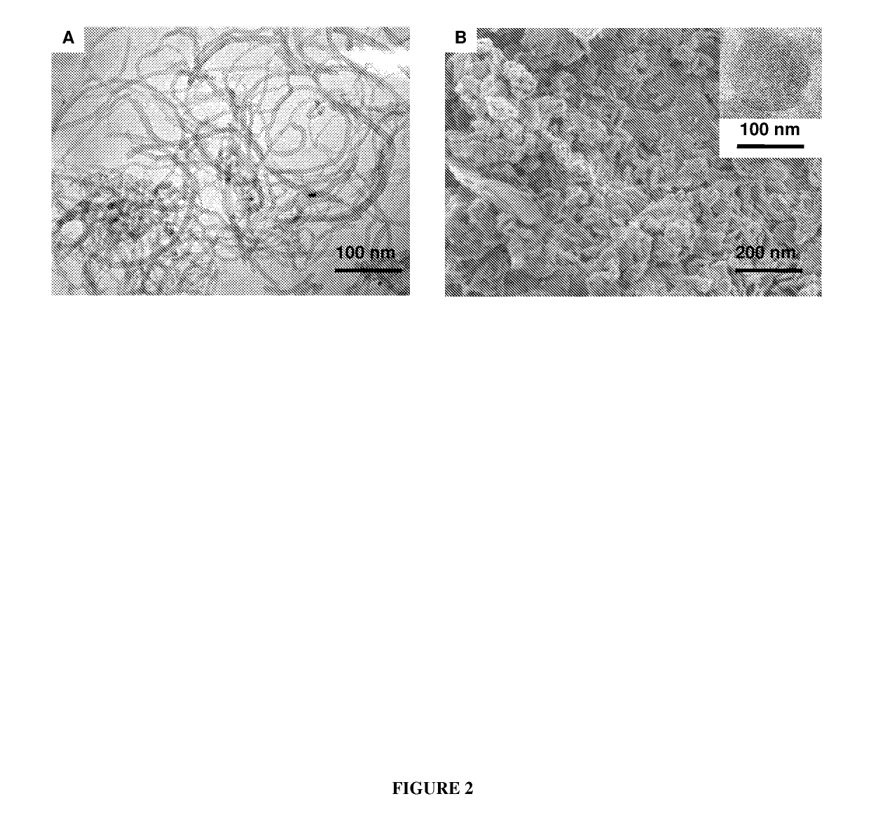

Preparation of Carbon Nanotubes (CNTs) and α-Zirconium Phosphate Nanoplatelets (ZrP): SWNTs were obtained from Carbon Nanotechnologies, Inc. and MWNTs were purchased from Aldrich. The CNTs were first oxidized in a mixture of concentrated sulfuric acid and concentrated nitric acid with a volume ratio of 3:1 by ultrasonication in a sonication bath for 2 hours. Then, de-ionized water was added to dilute the acids and the mixture was sonicated for another three hours. After the above processes, the oxidized CNTs were isolated by using a PVDF filter membrane (Millipore, 0.45 μm pore size) under vacuum. The CNTs were washed several times with de-ionized water during filtration to remove the acid residue. The CNTs collected were then re-dispersed in water by 3 hours of sonication. FIG. 2A shows the TEM image of oxidized MWNTs, which are highly entangled with each other.

α-ZrP nanoplatelets were synthesized through a refluxing method. Briefly, 15.0 g of ZrOCl₂.8H₂O (Fluka) was refluxed in 150.0 mL of 3.0 M H₃PO₄ (EM Science) in a Pyrex glass flask with stirring at 100° C. for 24 hours. After reaction, the products were washed three times through centrifugation and re-suspension. The products were dried at 85° C. in an oven for 24 hrs, and then gently ground with a mortar and pestle to form a fine powder. α-ZrP powders were exfoliated with tetra-n-butylammonium hydroxide (TBA⁺OH⁻, Aldrich, 1 mol/L in methanol) at a molar ratio of α-ZrP:TBA=1:0.8 in water. TEM images of the pristine and exfoliated ZrP nanoplatelets are shown in FIG. 2B.

Preparation of Epoxy Nanocomposites Containing MWNTs and ZrP: Two Aqueous solutions containing oxidized MWNTs and fully exfoliated ZrP nanoplatelets were directly mixed. The weight ratio of MWNTs to ZrP nanoplatelets is 1:5. The mixture was sonicated in a sonication bath (Branson 2510) maintained at room temperature for 30 min. The final concentrations of CNTs and ZrP are 200, and 1000 ppm, respectively, with a solution volume of 5 mL. The mixture was sonicated in a sonication bath (Branson 2510) maintained at room temperature for 30 min. After dispersion, the aqueous mixtures were dried on a hot plate at 100° C. for several hours with stirring until all water was removed.

After dispersion, ionic surfactant such as sodium dodecyl sulfate (SDS) or polystyrene sulfonate (PSS) was added to achieve a concentration of 1.0 wt %. The solution was then sonicated for another 30 min at room temperature. 5 mL of acetone was added into the solution to force CNTs to agglomerate immediately. The CNTs were collected by centrifugation at 5000 rpm for 15 min. The supernatant was decanted and then the CNTs were washed with acetone two more times and de-ionized water for three times. All the supernatants were collected and dried. The amount of nanoplatelets separated was calculated by weighing the residues (Note: residues contain separated nanoplatelets and surfactants). The Purified CNTs were then redispersed in aqueous solutions containing various surfactants, such as piperidine (water-soluble amine, cationic surfactant at neutral pH), SDS (anionic surfactant), PSS (poly anion), Polyvinyl pyrrolidone (PVP, non-ionic polymer). The SWNT solutions are stable for at least 3 months.

The residues were then redispersed in acetone by ultrasonication for 30 min. The redispersed MWNTs:ZrP with a weight ratio of 1:5 in acetone were mixed with epoxy monomer, diglycidyl ether of bisphenol-A (D.E.R.˜3˜3 2 epoxy resin, The Dow Chemical Company) to achieve a finial MWNT concentration of 0.2 and 0.4 wt % in epoxy nanocomposites (denoted as epoxylCNT1ZrP nanocomposites). The ZrP concentrations were 1.0 and 2.0 wt %, respectively. The solvent was then removed via rotary evaporation in a water bath at 80° C. and curing agent, 4,4′-diamino-diphenyl sulfone (DDS, Aldrich) was added at a stoichiometric ratio. This mixture was heated up rapidly to 130° C. until the DDS was dissolved and then poured into a pre-heated glass mold with mold release agent on the glass mold surfaces. The epoxies were cured in an oven at 180° C. for 2 hours, followed by 2 hours of post-cure at 220° C. For comparison purposes, neat epoxy samples were also prepared.

Characterization: Raman spectra of CNTs were obtained using a Horiba JY LabRam spectrometer. The absorption spectra of the CNTs in water were recorded on a Hitachi (model U-4100) UV-vis-NIR spectrophotometer. The reference spectrum for the measurements was de-ionized water. In certain instances, the spectra displays variability in the peak blue shifts and peak presence, that is at least partially attributable to CNT suppliers.

Transmission electron microscope imaging was performed using a JEOL 2010 high-resolution transmission electron microscope, operated at 200 kV. The solution samples were coated onto carbon grids and were then dried at room temperature. A Reichert-Jung Ultracut-E microtome was utilized to prepare thin sections of nanocomposites with thickness of 70-100 nm for TEM imaging. X-ray diffraction (XRD) patterns were recorded using a Bruker D8 Advanced Powder X-ray Diffractometer with Cu—K_{α} incident radiation (λ=1.5418 Å).

Mechanical Testing: Tensile properties of the epoxy samples were obtained through the ASTM D638-98 method. The tensile tests were performed using an MTS® servo-hydraulic test machine at a crosshead speed of 5.08 mm/min at ambient temperature. Young's modulus, tensile strength, and elongation at break of each sample were obtained based on at least five specimens and the average values and standard deviations were reported.

Results: The mechanism of dispersing CNTs using exfoliated nanoplatelets has been stated in our previous patent. The concept for redispersing SWNTs and ZrP nanoplatelets into polymer has also been introduced in the previous patent. Here, we show the improved steps for redispersing MWNTs and exfoliated ZrP into epoxy to form exfoliated nanocomposites. The corresponding mechanical properties and respective improvements are reported.

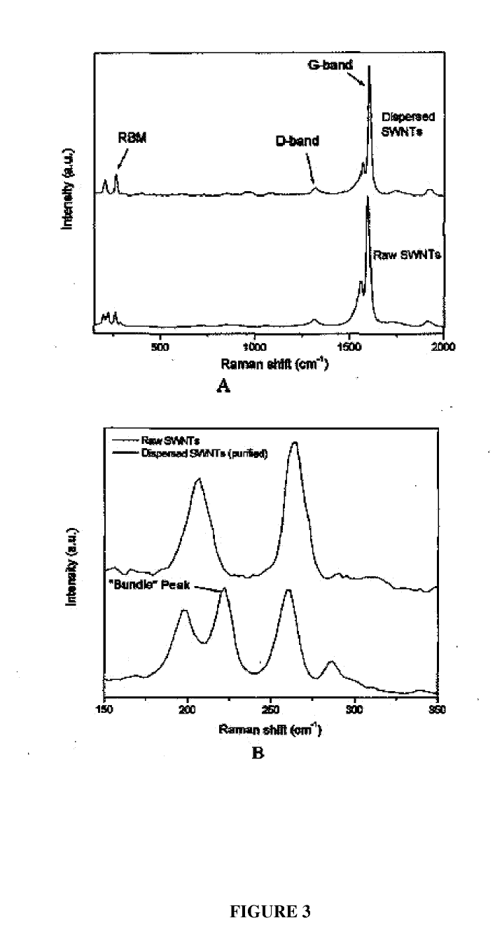

Raman spectroscopy is one of the most widely used tools to study SWNTs. FIG. 3A shows the Raman spectra of SWNTs before and after de-bundling. The Raman spectrum of SWNTs comprises three distinguished regions: 180-300 cm⁻¹, the Radial Breathing Modes (RBM); ˜1300 cm⁻¹, defect band (D-band); and 1600 cm⁻¹, tangential G-mode (G-band). The D-band indicates the presence of defects in the walls of SWNTs. The D-band of SWNTs after debundling/separation does not show any obvious change, suggesting that our dispersion and separation process does not cause detectable damage in SWNTs. Therefore, the electronic and mechanical properties are preserved after de-bundling and separation. This finding agrees with previous UV-vis-NIR spectroscopic results.

When SWNTs are exfoliated, the walls are relatively free of vibration compared with their bundle form. This leads to a blue shifting of G-band in Raman spectrum for individual SWNTs. In FIG. 3A, the G-band of the debundled and purified SWNTs through our approach is found to have blue-shifted by greater than about 5 cm⁻¹, compared to the untreated and bundled SWNTs. This also demonstrates the effectiveness of this approach to debundle SWNTs.

RBM is a complicated region of Raman spectrum. However, as pointed out in literature for HiPco SWNTs, when bundled, SWNT shows a distinguished peak at around 220 cm⁻¹, which is not the case for individual SWNTs. After debundling through our approach, the 220 cm⁻¹ peak disappears. This experimental observation also demonstrates that our approach can fully exfoliate SWNT bundles into individual tubes.

Table 1 shows the efficiency of our new invention to separate nanoplatelets from

TABLE 1

| | Percentage of nanoplatelets removed from SWNTs |
|---|---|
| Electronic screening | 98.2% ± 10.2% |
| SDS + Acetone | 90.5% ± 10.2% |
| PSS + Acetone | 96.6% ± 10.8% |

debundled SWNTs compared to the previous electrostatic screening method. Due to precision control of ionic concentration in the solvent, this method becomes much easier than the previous method to achieve exfoliation and separation of CNT from nanoplatelets. Most importantly, this new method can easily separate nanoplatelets from MWNTs as illustrated in Table 2, which was not demonstrated previously. Table 2 illustrates the comparison of different methods for the separation efficiency of nanoplatelets from MWNTs. Both Table 1 and 2 illustrate the separation efficiency for nanotubes, however, the MWNTs exhibit a lower separation efficiency. Using either class of CNTs, the separation efficiency is predicted to be at least about 50%.

TABLE 2

| | Percentage of nanoplatelets removed from MWNTs |
|---|---|
| Electronic screening | — |
| SDS + Acetone | 92.3% ± 10.9% |
| PSS + Acetone | 97.6% ± 10.8% |

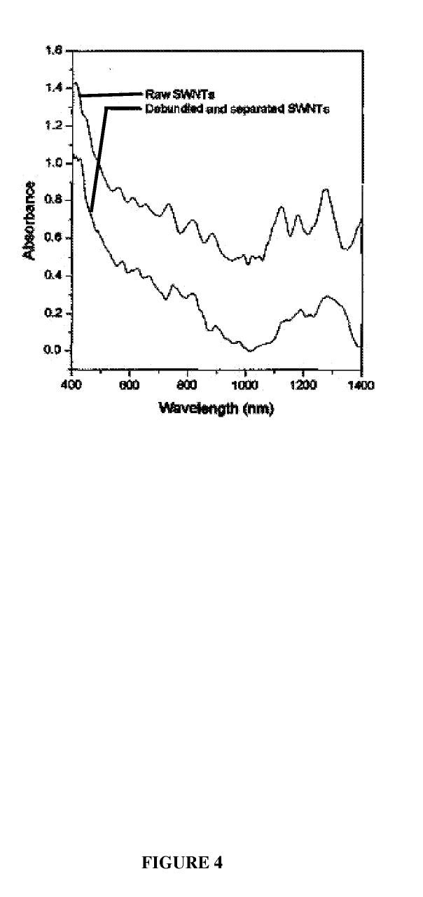

FIG. 4 shows the UV-vis-NIR spectra of SWNTs before and after debundling and separation using the new method. The more pronounced peaks from debundled SWNTs indicate that most of the SWNTs have been exfoliated and the tube wall structures have been well preserved during our debundling and separation process. However, experimental observation illustrates that the distinguished peak may be less distinguished dependent on the source and/or supplier of the CNTs.

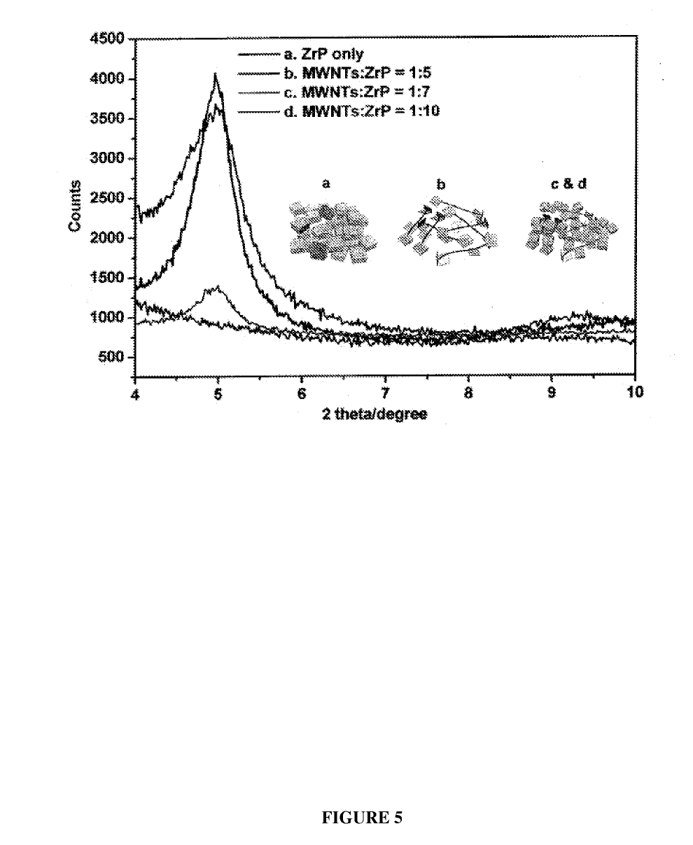

The concept for re-dispersing exfoliated nanoplatelets and carbon nanotubes in polymers is summarized in FIG. 1. After drying the aqueous suspension 10, containing dispersed CNTs 12 and exfoliated nanoplatelets 14, these two nanoparticles have a close contact with each other and form a loose structure or nanofiller 16, which favors further redispersion 18 in solvents. Specifically, exfoliated nanoplatelets 14 normally restack and form layered structures 20 after drying. However, the strong short-range van de Waals forces bind the layered structures 20, thereby making them unable to be redispersed. In the presence of dispersed CNTs 12, they no longer restack as they associate with the CNTs to form a loose structure 16. Further, the presence of nanoplatelets also prevents CNTs from re-aggregation and re-entanglement 22. XRD results support this idea as illustrated in FIG. 5. Without CNTs, exfoliated ZrP nanoplatelets restack and form layered structures as illustrated by the XRD peak in FIG. 5a. When the ratio between MWNTs and exfoliated ZrP nanoplatelets is 1:5, the XRD scattering peak disappears. As illustrated in FIG. 5b, indicating amorphous structures of the MWNTs/ZrP hybrid. As the ratio decreases to 1:7, FIG. 5c and 1:10, FIG. 5d, the XRD peaks can be observed again. These peaks come from the addition ZrP nanoplatelets that have restacked into layered structures. This result also shows that a ratio between MWNTs and ZrP nanoplatelets of 1:5 is an optimal ratio to obtain dispersed MWNTs and fully exfoliated ZrP nanoplatelets through the drying-redispersion approach. If this ratio is increased the dispersion decreases. Alternatively, the addition of CNTs leads to an increase in the aggregation and entanglement of CNT with each other. Further, in the opposite manner, if this ratio is reduced, excessive ZrP nanoplatelets restack irreversibly.

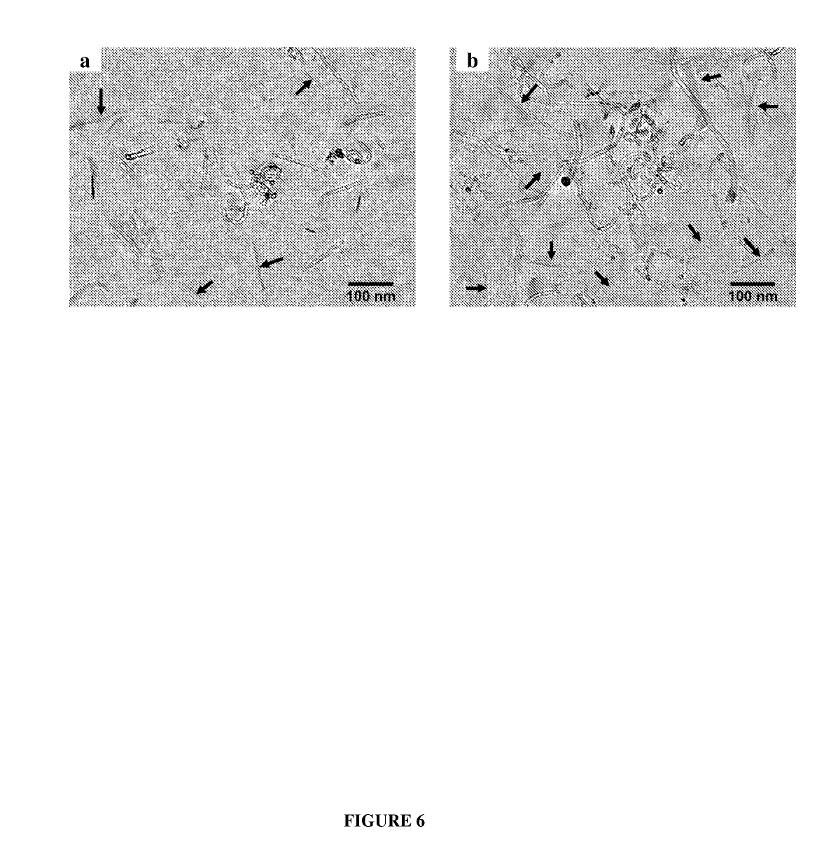

FIG. 6 shows the TEM images of epoxy nanocomposites containing MWNTs and exfoliated ZrP nanoplatelets prepared through the drying-redispersion process at the optimal ratio of 1:5. FIG. 6 shows the TEM images of epoxy nanocomposites with 0.2 and 0.4 wt. % of MWNTs. The concentrations of exfoliated nanoplatelets are 1.0 and 2.0 wt %, respectively. Well-dispersed MWNTs and full exfoliation of nanoplatelets can be observed. The TEM images shown here clearly suggest that through the aqueous dispersion, organic redispersion approach, both MWNTs and nanoplatelets can be fully dispersed down to individual level in epoxy matrices. The most important reason for achieving such a good dispersion is the proper manipulation of the surface characteristics of both CNTs and nanoplatelets so that they have strong affinity with each other due to the electrostatic attraction between opposite charges.

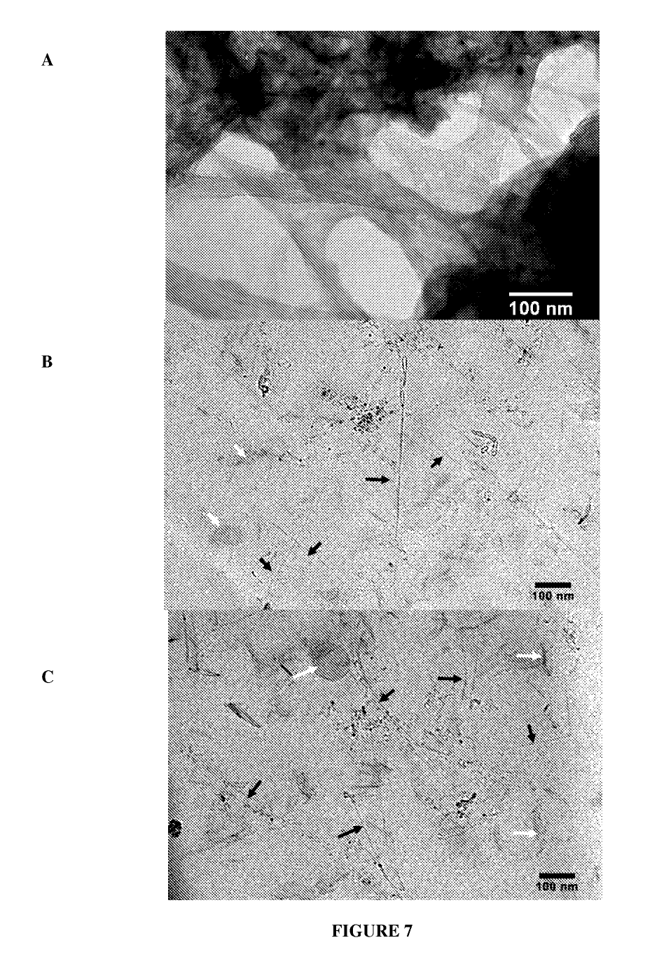

Further, the effectiveness of the above approach to exfoliate bundled SWNTs in epoxy is shown in FIG. 7. The pretreated-SWNTs are still in a bundled state with significant bundle-to-bundle entanglements (FIG. 7a). After mixing with exfoliated ZrP nanoplatelets using the above drying-redispersion method, SWNTs can be fully debundled and well dispersed in epoxy matrix as in FIGS. 7b and 7c. The ZrP nanoplatelets have maintained their exfoliated morphology, as well. It should be noted that after debundling, SWNTs become straight in epoxy matrix, while it is not the case for the MWNTs. This is because of the fact that SWNTs possess nearly perfect structure with high stiffness, allowing the tube to remain straight even after curing of epoxy.

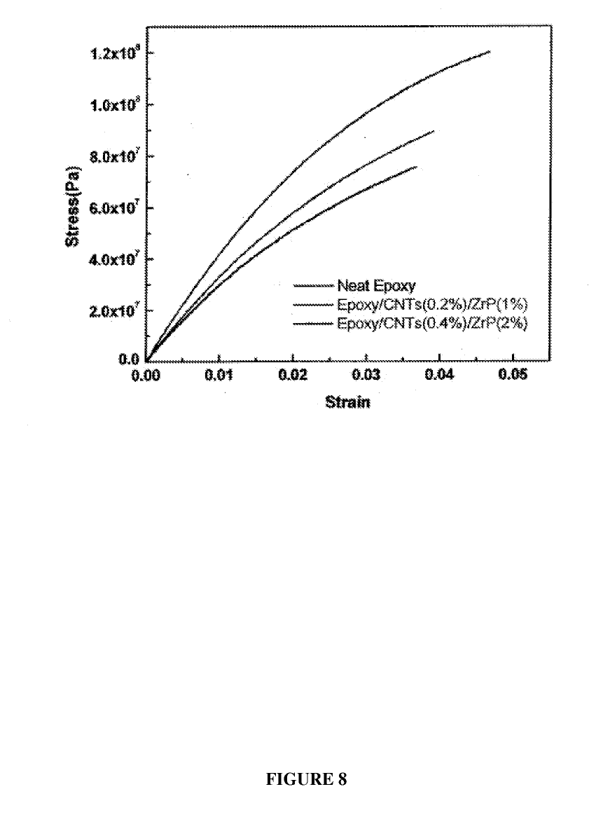

Tensile testing results in Table 3 and further in FIG. 8 show that the Young's modulus, tensile strength, and elongation at break of the epoxy nanocomposites increase up to 40%, 55%, and 16%, respectively, at a mere nanotube concentration of 0.4 wt. % and the nanoplatelet concentration of 2.0 wt. %.

TABLE 3

| | Neat | Epoxy/CNTs(0.2%)/ | Epoxy/CNTs(0.4%)/ |
|---|---|---|---|
| | Epoxy | ZrP(1.0%) | ZrP(2.0%) |
| Young's | 3.04 ± 0.04 | 3.40 ± 0.06 | 4.27 ± 0.07 |
| Modulus (GPa) | | | |
| Tensile | 75.3 ± 4.2 | 83.1 ± 4.8 | 116 ± 5.5 |
| Strength (MPa) | | | |
| Elongation at | 3.7 ± 0.1 | 3.9 ± 0.3 | 4.3 ± 0.4 |
| Break (%) | | | |

In conclusion, we have developed a simple and effective drying-redispersion method to disperse carbon nanotubes and inorganic nanoplatelets into epoxy to form exfoliated epoxy nanocomposites. The epoxy nanocomposites containing fully exfoliated nanoplatelets and well-dispersed carbon nanotubes show exceptionally good mechanical properties at low CNT concentrations.

The discussion of a reference in the Description of the Related Art is not an admission that it is prior art to the present invention, especially any reference that may have a publication date after the priority date of this application. The disclosures of all patents, patent applications, and publications cited herein are hereby incorporated herein by reference in their entirety, to the extent that they provide exemplary, procedural, or other details supplementary to those set forth herein.

We claim:

1. A nanocomposite, comprising:
a medium, wherein the medium comprises a matrix; and
a nanofiller, wherein the nanofiller comprises at least one exfoliated nanotube disposed within the medium.

2. The nanocomposite of claim 1, wherein the medium is selected from the group consisting of thermosets, thermoplastics, and combinations thereof.

3. The nanocomposite of claim 1, wherein the nanofiller comprises:
at least one nanoplatelet; and
at least one exfoliated nanotube having a chemical association with the nanoplatelet.

4. The nanocomposite of claim 3, wherein the nanoplatelet comprises a material selected from the group consisting of clay, nanoclay, graphite, inorganic crystal, organic crystal, and combinations thereof.

5. The nanocomposite of claim 3, wherein the at least one exfoliated nanotube comprises a carbon nanotube.

6. The nanocomposite of claim 5, wherein the carbon nanotube comprises at least one selected from the group consisting of multi-walled carbon nanotubes, single walled carbon nanotubes, and combinations thereof.

7. The nanocomposite of claim 4, wherein the at least one exfoliated nanotube is reversibly associated with at least one nanoplatelet

8. The nanocomposite of claim 6, further comprising a nanoplatelet-to-nanotube mass ratio of at least 0.5:1.

9. A nanocomposite, comprising:
a matrix; and
a nanofiller comprising at least one exfoliated nanotube within the matrix.

10. The nanocomposite of claim 9, wherein the matrix is selected from the group consisting of epoxies, plastics, polymers, thermosets, thermoplastics, and combinations thereof.

11. The nanocomposite of claim 9, wherein the at least one exfoliated nanotube comprises a carbon nanotube.

12. The nanocomposite of claim 11, wherein the carbon nanotube is selected from the group consisting of multi-walled carbon nanotubes, single walled carbon nanotubes, and combinations thereof.

13. A process for manufacturing a nanocomposite, comprising:
a) adding at least one nanotube to a first solution, wherein the first solution functionalizes the nanotube;
b) isolating the nanotube from the first solution and resuspending the nanotube in an aqueous solvent to form a functionalized nanotube solution;
c) adding at least one nanoplatelet to a second solution, wherein the second solution exfoliates the nanoplatelet, to form an exfoliated nanoplatelet solution;
d) admixing the functionalized nanotube solution and exfoliated nanoplatelet solution to form a nanofiller solution;
e) drying the nanofiller solution the mixture to form a powder;
f) resuspending the powder in a surfactant, to form a nanofiller precursor;
g) admixing the nanofiller precursor into a medium precursor solution; and
h) curing the medium precursor solution to form a nanocomposite comprising a nanofiller.

14. The process of claim 13, wherein the carbon nanotube is selected from the group consisting of multi-walled carbon nanotubes, single walled carbon nanotubes, and combinations thereof.

15. The process of claim 13, wherein the nanoplatelet comprises a material selected from the group consisting of clay, nanoclay, graphite, inorganic crystal, organic crystal, and combinations thereof.

16. The process of claim 13, wherein the nanofiller solution comprises, at least one exfoliated nanoplatelet associated with at least one oxidized nanotube.

17. The process of claim 16, wherein admixing the oxidized nanotube solution and the exfoliated nanoplatelet solution comprises admixing at a nanotube-to-nanoplatelet mass ratio of at least 10:1.

18. The process of claim 16, wherein the at least one oxidized nanotube is exfoliated by reversible association with at least one exfoliated nanoplatelet.

19. The process of claim 13, wherein the precursor solution is selected from the group consisting of epoxies, plastics, polymers, thermosets, thermoplastics, and combinations thereof.

20. An method of making a carbon nanotube nanocomposite, comprising:
a) adding at least one nanotube to a first solution, wherein the first solution oxidizes the at least one nanotube;
b) isolating the at least one nanotube from the first solution and resuspending the at least one nanotube in an aqueous solvent to form an oxidized nanotube solution;
c) adding at least one nanoplatelet to a second solution, wherein the second solution exfoliates the at least one nanoplatelet;
d) isolating the nanoplatelet from the base solution and re-suspending the at least one nanotube in the solvent to form an exfoliated nanoplatelet solution;
e) admixing the oxidized nanotube solution and exfoliated nanoplatelet solution to form a nanofiller solution comprising at least one exfoliated nanotube associated with the at least one nanoplatelet;
f) admixing at least one solvent to the nanofiller solution, to form an agglomerated nanotube-nanoplatelet solution;
g) removing the at least one nanotube from the agglomerated nanotube-nanoplatelet solution;
h) resuspending the at least one nanotube to form an isolated nanotube dispersion; and
i) admixing the isolated nanotube dispersion in a matrix precursor solution to form a carbon nanotube nanocomposite.

21. The method of claim 20, wherein admixing at least one solvent to the nanofiller solution comprises admixing a polar solvent.

22. The method of claim 20 wherein the solvent is selected from the group consisting of organic polar solvents, tetrahydrofuran, acetone, alcohol, and combinations thereof.

23. The method of claim 22, wherein the solvent comprises a polar aprotic solvent.

24. The method of claim 20, wherein admixing at least one solvent nanotube further comprises stabilizing the nanotubes.

25. The method of claim 20, wherein removing the at least one nanotube from the agglomerated nanotube-nanoplatelet solution is selected from the group consisting of centrifuging the nanotube-nanoplatelet solution, altering salt concentration, altering the pH, and combinations thereof.

26. The method of claim 20, wherein resuspending the at least one nanotube comprises:
washing the at least one nanotube; and
resuspending the at least one nanotube in a surfactant.

27. The method of claim 20, wherein the at least one carbon nanotube is selected from the group consisting of multi-walled carbon nanotubes, single walled carbon nanotubes, and combinations thereof.

28. The method of claim 20, wherein admixing the isolated nanotube dispersion in a matrix precursor solution comprises admixing the isolated nanotube dispersion in a precursor solution selected from the group consisting of epoxies, plastics, polymers, conjugated polymers, thermosets, thermoplastics, and combinations thereof.

29. The method of claim 20, wherein admixing the isolated nanotube dispersion in a matrix precursor solution further comprises curing the precursor solution.

30. A nanocomposite comprising;
exfoliated carbon nanotubes having at least one wall; and
an epoxy matrix having a first liquid state, and a second solid state.

31. The nanocomposite of claim 29, wherein the exfoliated carbon nanotubes are dispersed in the first state of the epoxy matrix.
